(19) United States
(12) Patent Application Publication
(10) Pub. No.: US 2021/0282585 A1
(43) Pub. Date: Sep. 16, 2021

(54) CUP LID STRUCTURE

(71) Applicant: HYDY Inc., Los Angeles, CA (US)

(72) Inventor: Chenyu Andrew Lee, Los Angeles, CA (US)

(21) Appl. No.: 16/864,626

(22) Filed: May 1, 2020

(30) Foreign Application Priority Data
Mar. 10, 2020 (TW) 109202710

(51) Int. Cl. A47J 31/20; B65D 51/28; B65D 43/02

(52) U.S. Cl. CPC A47J 31/20; B65D 2543/00092; B65D 43/0229; B65D 51/28

(57) ABSTRACT

The present invention discloses a cup lid structure covering on an external cup and including: a lid having a body portion; a first joint portion provided on a bottom end of the body portion for connecting with the external cup; a straw insertion hole penetrating through the body portion; and a flexible positioning element provided on the body portion and normally closing the straw insertion hole, wherein the positioning element is recoverably deformable to allow an external straw to pass through the straw insertion hole, so that the straw is positioned, users can directly access the beverage in the cup without opening the cup lid conveniently, and the convenience in usage is improved.

### BACKGROUND OF THE INVENTION

### Field of Invention

The present invention relates to containers, and more particularly to a cup lid structure.

### Related Art

With the rising awareness of environmental protection, many people often carry thermos cups when they go out, and the commercially available thermos cup mainly include: a cup and a cup lid, which can hold drinks in the cup, and the cup lid is disposed on the cup, thereby a cup rim of the cup is closed to avoid the situation of drink overflow and leakage. However, when consumers want to drink, the cup lid must be removed from the cup, and the cup lid has to be placed back on the cup after use, and open the cup lid again the next time they want to drink. Such repeated actions are quite cumbersome and inconvenient.

In addition, in order to make it convenient for users to brew tea leaves, coffee powder or other brewing materials with a thermos cup, usually the brewing material is first put into a filter element, and then the filter element is connected to the cup lid. Then, when the cup lid is covered on the cup, the filter element is located in an inner space of the cup, and the beverage is brewed for users to drink. However, in such an assembly method, a connection structure for combining with the filter element is necessarily provided on the cup lid, which not only easily increases the difficulty of disassembly or assembly between the two, but also because of the design of the connection structure provided on the cup lid, dead corners are formed to make cleaning difficult, and after long-term use, it is easy to accumulate dirt and cause trouble of cleaning for users.

In view of this, how to improve the problems caused by the conventional cup lids will be considered by relevant manufacturers.

### SUMMARY OF THE INVENTION

A main object of the present invention is to provide a cup lid structure capable of being inserted with and positioning a straw, so that users can directly access the beverage in a cup without opening the cup lid conveniently, and the convenience in usage is improved.

In order to achieve the above-mentioned object, the present invention provides a cup lid structure covering on an external cup and including: a lid having a body portion; a first joint portion provided on a bottom end of the body portion for connecting with the external cup; a straw insertion hole penetrating through the body portion; and a flexible positioning element provided on the body portion and normally closing the straw insertion hole, wherein the positioning element is recoverably deformable to allow an external straw to pass through the straw insertion hole.

Further, in order to securely combine the lid with the external cup, the first joint portion has a first peripheral wall connected to the bottom end of the body portion adjacent to a periphery of the body portion, and extending a distance downward from the body portion, and a first screw thread is provided along an outer wall surface of the first peripheral wall for screwing and connecting with the external cup.

In order to guide or limit a liquid overflowing from the straw insertion hole, the lid further includes a ring flange extending outward from a top end of the body portion, and there is an inclination angle between an axial cross-section of a circular center of the ring flange and the body portion.

Wherein the lid further includes a plate pivotally disposed on the top end of the body portion and covering an area surrounded by the ring flange, when the plate pivots relative to the body portion, the straw insertion hole can be opened or covered, so that the straw insertion hole is blocked from the outside to prevent external dust or pollutants from falling into the cup through the straw insertion hole, otherwise will cause sanitary problems.

Wherein a center of a top surface of the positioning element is concavely provided with a concave surface, and crisscross slits are provided at the concave surface, so as to grip the external straw when passing through the slits to achieve an object of positioning the external straw.

Wherein the body portion is round, and an outer diameter of the body portion is larger than an inner diameter of the external cup.

Another object of the present invention is to provide a cup lid structure capable of arbitrarily assembling or disassembling a tea filter on the cup lid by using a connecting member to avoid the cup lid being additionally designed with structures with dead corners to accumulate dirt easily, which greatly improves the convenience in cleaning and the flexibility in use.

In order to achieve the above-mentioned objects, the present invention provides a cup lid structure covering on an external cup and including: a lid having a body portion, a first joint portion provided on a bottom end of the body portion for connecting with the external cup, and a first positioning portion provided on the first joint portion; and a connecting member having a body, a second joint portion provided on a bottom end of the body to connect with an external tea filter, and a second positioning portion provided on the body, wherein the first positioning portion and the second positioning portion are configured in corresponding convex-concave shapes so as to fit and connect with each other, so that the connecting member is connected with the lid.

Further, the first joint portion has a first peripheral wall connected to the bottom end of the body portion adjacent to a periphery of the body portion, and extending a distance downward from the body portion; the first positioning portion has at least two recesses respectively disposing on the first peripheral wall, each of the recesses extends from an end portion of the first peripheral wall toward the body portion; and the second positioning portion has at least two protrusions protruded from a periphery of the body and corresponding to the recesses respectively.

Wherein each of the recesses is divided into three sections from a starting point to a tail end of the extension, which are respectively a vertical section away from the body portion, a horizontal section adjacent to the body portion, and a bent section between the vertical section and the horizontal section.

Wherein the second joint portion has a second peripheral wall connected to the body and extending a distance downward from the body, and a second screw thread is provided along an inner wall surface of the second peripheral wall for screwing and connecting with the external tea filter.

### BRIEF DESCRIPTION OF THE DRAWINGS

FIG. 1 is a perspective view of a cup lid structure disclosed in an embodiment of the present invention being in a state that a lid is connected with a tea filter and a straw;

FIG. 2 is an exploded perspective view of FIG. 1;

FIG. 3 is a perspective view of a connecting member of FIG. 2 viewed from another angle;

FIG. 4 is a partial cross-sectional view of FIG. 1 along the direction of 4-4;

FIG. 5 is a cross-sectional view in FIG. 4 showing a state in which the lid is covered on a cup; and

FIG. 6 is a cross-sectional view of the cup lid structure in FIG. 5 of an embodiment of the present invention being in a state that the lid is not connected with the tea filter and the straw.

### DETAILED DESCRIPTION OF THE INVENTION

An embodiment of the present invention will be exemplified and further explained hereinafter with accompanying drawings.

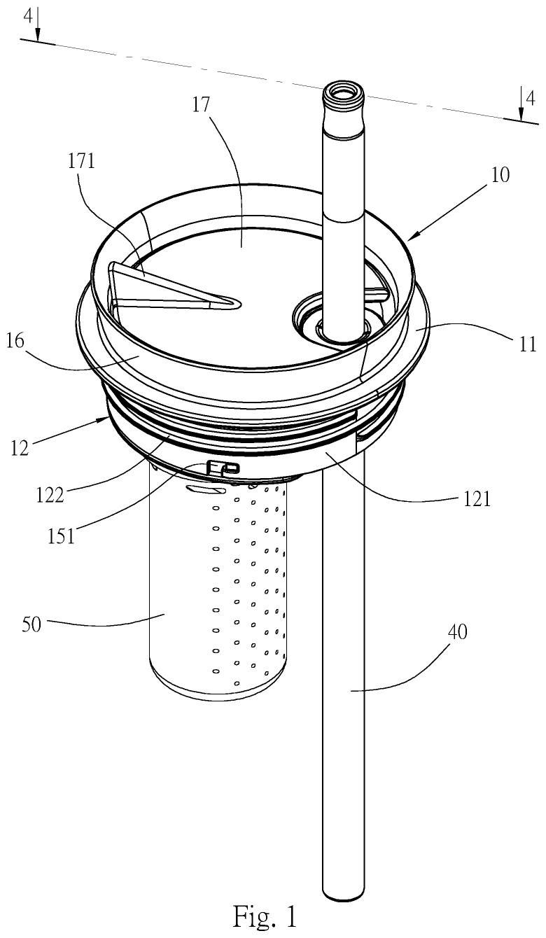

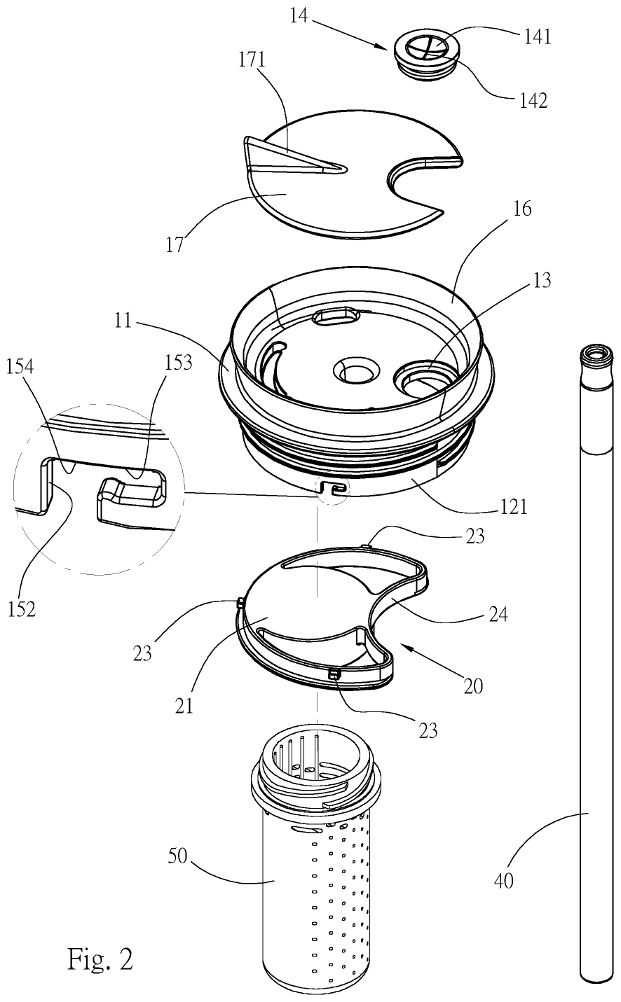

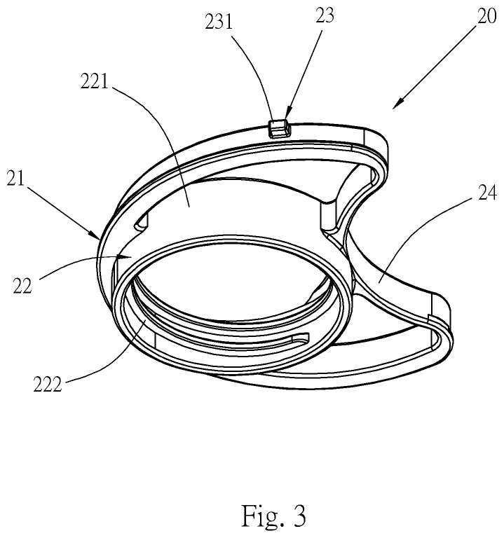

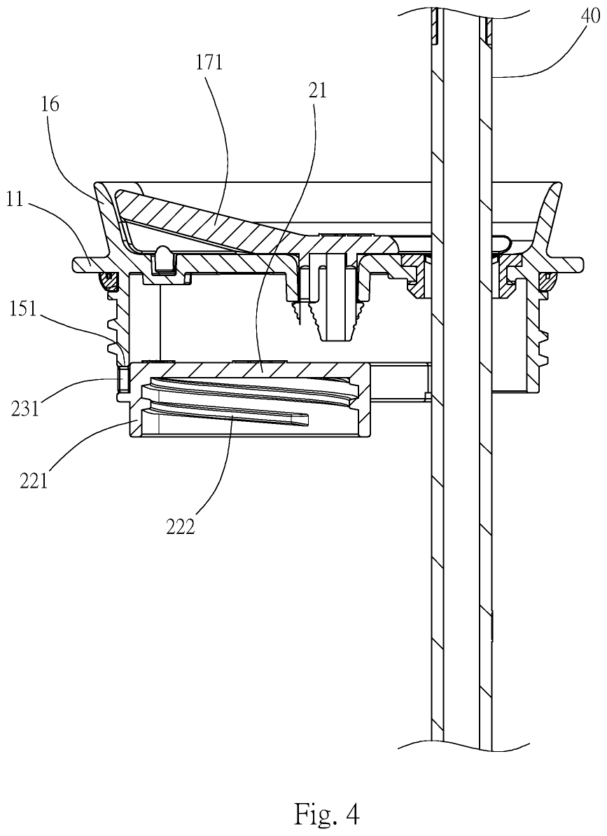

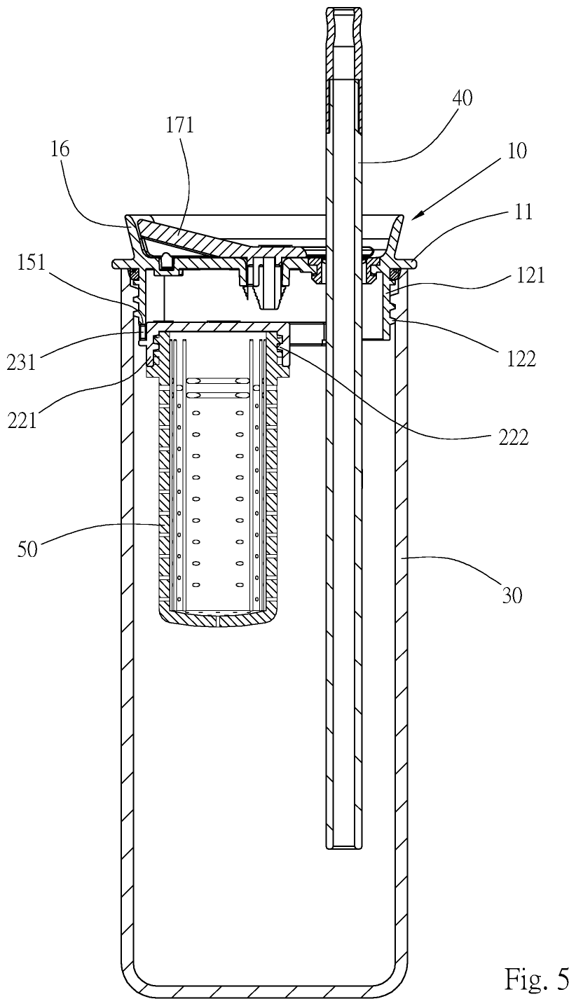

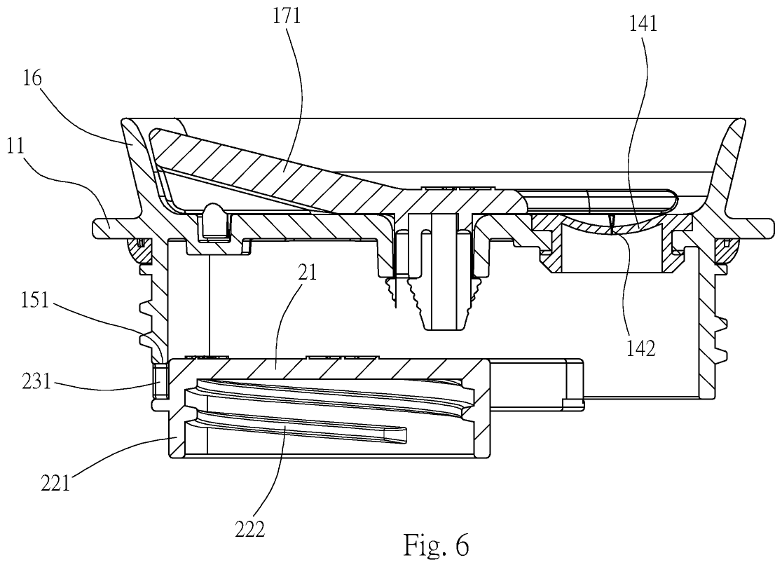

Please refer to FIG. 1 to FIG. 6. A cup lid structure disclosed in one embodiment of the present invention is covered on an external cup 30, and mainly includes a lid 10 and a connecting member 20, wherein:

the lid 10 has a body portion 11 being a circular plate, an outer diameter of the body portion 11 is greater than an inner diameter of the external cup 30; a first joint portion 12 provided on a bottom end of the body portion 11 for connecting with the external cup 30; a straw insertion hole 13 penetrating through the body portion 11; a flexible positioning element 14 provided on the body portion 11 and normally closing the straw insertion hole 13, and the positioning element 14 is recoverably deformable to allow an external straw 40 to pass through the straw insertion hole 13; a first positioning portion 15 provided on the first joint portion 12; a ring flange 16 extending outward from a top end of the body portion 11, and there is an inclination angle between an axial cross-section of a circular center of the ring flange 16 and the body portion 11; and a plate 17 pivotally disposed on the top end of the body portion 11 and covering an area surrounded by the ring flange 16, when the plate 17 pivots relative to the body portion 11, the straw insertion hole 13 can be opened or covered.

In this embodiment, the first joint portion 12 has a first peripheral wall 121 connected to the bottom end of the body portion 11 adjacent to a periphery of the body portion 11, and extending a distance downward from the body portion 11, and a first screw thread 122 is provided along an outer wall surface of the first peripheral wall 121 for screwing and connecting with the external cup 30.

The first positioning portion 15 has at least two recesses 151 respectively disposing on the first peripheral wall 121, each of the recesses 151 extends from an end portion of the first peripheral wall 121 toward the body portion 11. Wherein each of the recesses 151 is divided into three sections from a starting point to a tail end of the extension, which are respectively a vertical section 152 away from the body portion 11, a horizontal section 153 adjacent to the body portion 11, and a bent section 154 between the vertical section 152 and the horizontal section 153.

A center of a top surface of the positioning element 14 is concavely provided with a concave surface 141, and crisscross slits 142 are provided at the concave surface 141.

A top surface of the plate 17 is further protrudingly provided with a push portion 171 for users to hold and rotate the plate 17.

The connecting member 20 has a body 21 with a shape configured corresponding to a shape formed by the first peripheral wall 121, so that the body 21 and the first peripheral wall 121 can be fitted with each other; a second joint portion 22 provided on a bottom end of the body 21 to connect with an external tea filter 50; and a second positioning portion 23 provided on the body 21, wherein the first positioning portion 15 and the second positioning portion 23 are configured in corresponding convex-concave shapes so as to fit and connect with each other, so that the connecting member 20 is connected with the lid 10.

In this embodiment, the second joint portion 22 has a second peripheral wall 221 connected to the body 21 and extending a distance downward from the body 21, and a second screw thread 222 is provided along an inner wall surface of the second peripheral wall 221 for screwing and connecting with the external tea filter 50. In other embodiments, in addition to screwing connection manner, the tea filter 50 and the connecting member 20 can also be connected by other combination manners such as fitting, snapping, etc., which can also achieve the efficacies disclosed in present invention.

The second positioning portion 23 has at least two protrusions 231 protruded from a periphery of the body 21 and corresponding to the recesses 151 respectively to ensure that the combination of the connecting member 20 and the lid 10 is located at the correct position, and users can conveniently align and fix the connecting member 20 with the lid 10.

In addition, the connecting member 20 further includes a recessed portion 24, which is recessed from the periphery of the body 21 toward the body 21 inwardly, so that a make-way space 241 is formed between the connecting member 20 and the lid 10 to allow the external straw 40 to pass through.

The cup lid structure composed of the above-mentioned components and disclosed in the present invention is capable of allowing the straw 40 passing through the slits 142 of the positioning element 14 directly to be positioned on the lid 10, and in a state that the lid 10 is still closing the cup body 30, it is convenient for users to access a drink in the cup 30, and the convenience in use is improved.

Furthermore, when users want to brew tea leaves or coffee powder, the brewing material can be put into the tea filter 50 first, and then screw the tea filter 50 to connect with the connecting member 20. At this time, the body 21 closes an opening of the tea filter 50, so that during the assembly and disassembly process, the brewing material can be prevented from carelessly falling out and spilling out of the tea filter 50, otherwise the environment will be made dirty and messy.

Then, the connecting member 20 is placed on the lid 10. In detail, each of the projections 231 is first fitted in the vertical section 152 of the corresponding recess 151; then, the connecting member 20 is pushed upwardly toward the lid 10 to move the projection 231 to the bent section 154 of the recess 151; finally, the connecting member 20 is rotated horizontally to make each of the projections 231 to locate in the horizontal section 153 of the recess 151. In such a combination manner, the lid 10 can be prevented from being additionally disposed with connection structures with dead corners to accumulate dirt easily, which greatly improves the convenience in cleaning and the flexibility in use.

Finally, when the lid 10 is covered on the cup 30, the brewing material of the tea filter 50 can be soaked in a solution in the cup 30, so as to achieve the object of brewing.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. A cup lid structure covering on an external cup and including:
a lid having a body portion; a first joint portion provided on a bottom end of the body portion for connecting with the external cup; a straw insertion hole penetrating through the body portion; and a flexible positioning element provided on the body portion and normally closing the straw insertion hole, wherein the positioning element is recoverably deformable to allow an external straw to pass through the straw insertion hole.

2. The cup lid structure as claimed in claim 1, wherein the first joint portion has a first peripheral wall connected to the bottom end of the body portion adjacent to a periphery of the body portion, and extending a distance downward from the body portion, and a first screw thread is provided along an outer wall surface of the first peripheral wall for screwing and connecting with the external cup.

3. The cup lid structure as claimed in claim 1, wherein the lid further includes a ring flange extending outward from a top end of the body portion, and there is an inclination angle between an axial cross-section of a circular center of the ring flange and the body portion.

4. The cup lid structure as claimed in claim 3, wherein the lid further includes a plate pivotally disposed on the top end of the body portion and covering an area surrounded by the ring flange, when the plate pivots relative to the body portion, the straw insertion hole can be opened or covered.

5. The cup lid structure as claimed in claim 1, wherein a center of a top surface of the positioning element is concavely provided with a concave surface, and crisscross slits are provided at the concave surface.

6. The cup lid structure as claimed in claim 1, wherein the body portion is round, and an outer diameter of the body portion is larger than an inner diameter of the external cup.

7. A cup lid structure covering on an external cup and including:
a lid having a body portion, a first joint portion provided on a bottom end of the body portion for connecting with the external cup, and a first positioning portion provided on the first joint portion; and
a connecting member having a body, a second joint portion provided on a bottom end of the body to connect with an external tea filter, and a second positioning portion provided on the body, wherein the first positioning portion and the second positioning portion are configured in corresponding convex-concave shapes so as to fit and connect with each other, so that the connecting member is connected with the lid.

8. The cup lid structure as claimed in claim 7, wherein the first joint portion has a first peripheral wall connected to the bottom end of the body portion adjacent to a periphery of the body portion, and extending a distance downward from the body portion; the first positioning portion has at least two recesses respectively disposing on the first peripheral wall, each of the recesses extends from an end portion of the first peripheral wall toward the body portion; and the second positioning portion has at least two protrusions protruded from a periphery of the body and corresponding to the recesses respectively.

9. The cup lid structure as claimed in claim 8, wherein each of the recesses is divided into three sections from a starting point to a tail end of the extension, which are respectively a vertical section away from the body portion, a horizontal section adjacent to the body portion, and a bent section between the vertical section and the horizontal section.

10. The cup lid structure as claimed in claim 7, wherein the second joint portion has a second peripheral wall connected to the body and extending a distance downward from the body, and a second screw thread is provided along an inner wall surface of the second peripheral wall for screwing and connecting with the external tea filter.
